(19) United States
(12) Patent Application Publication
(10) Pub. No.: US 2002/0094130 A1
(43) Pub. Date: Jul. 18, 2002

(54) Noise filtering an image sequence

(76) Inventors: Wilhelmus Hendrikus Alfonsus Bruls, Eindhoven (NL); Leonardo Camiciotti, Eindhoven (NL); Gerard De Haan, Eindhoven (NL); Richard Petrus Kleihorst, Eindhoven (NL); Albert Van Der Werf, Eindhoven (NL)

Correspondence Address: U.S. Philips Corporation, 580 White Plains Road, Tarrytown, NY, 10591, US

(21) Appl. No.: 09/880,207

(22) Filed: Jun. 13, 2001

(30) Foreign Application Priority Data
Jun. 15, 2000 (EP) 00202076.6

(51) Int. Cl. G06K 9/40; G06T 5/00

(52) U.S. Cl. 382/261; 382/262

(57) ABSTRACT

Noise filtering an image sequence (V1) is provided wherein statistics (S) in at least one image of the image sequence (V1) is determined (11) and at least one filtered pixel value (Pₜ′) is calculated from a set of original pixel values (Pₜ, Mᵢ) obtained from the at least one image, wherein the original pixel values (Pₜ, Mᵢ) are weighted (13) under control (12, α) of the statistics (11).

The invention relates to noise filtering an image sequence. The invention further relates to encoding an image sequence, wherein the image sequence is noise filtered.

It is well known that image sequences generally contain noise that may arise either during the initial stage of image acquisition, or during the processing and transmission operations or even during the storing stage. This noise not only degrades the quality of the sequence but also the performance of subsequent possible compression operations (e.g. MPEG, wavelet, fractal, etc.). For these reasons there is a great interest in reducing the noise as much as possible without unacceptably affecting the image quality.

To reduce the noise, a filtering operation is necessary. Such a filtering operation may result in blurring and ‘ghost’ effects in the image, that result in an unacceptable quality for the viewer. This is due to the fact that almost all images have detailed areas, with edges, contours, etc.

An object of the invention is to provide advantageous filtering. To this end, the invention provides a method and device for noise filtering an image sequence and a method and device for encoding an image sequence, as defined in the independent claims. Advantageous embodiments are defined in the dependent claims.

In a first embodiment of the invention, statistics in at least one image of the image sequence are determined, and at least one filtered pixel value is calculated from a set of original pixel values obtained from the at least one image, wherein the original pixel values are weighted under control of the statistics. The invention provides a simple method to perform an adaptive filtering, which is preferably applied in a pre-processing stage of a compression system. Statistics may be easily obtained from the at least one image by any known (or yet unknown) calculation, e.g. variance or correlation (or approximation thereof) in a (sub-set) of the at least one image.

In a further embodiment of the invention, the step of calculating comprises weighting the set of original pixel values under control of the statistics to obtain a weighted set of pixel values and furnishing the weighted set of pixel values to a static filter, in which static filter the at least one filtered pixel value is calculated from the weighted set of pixel values. This embodiment has, inter alia, the advantage that adaptivity of the filtering is obtained by using a separate weighting step and that a static filter is used in combination with the weighting. Instead of using a variable filter, which implementation is more complicated, the invention provides a simple adaptation of the pixel values, which in combination with a static filter results in adaptive filtering.

Advantageously, the statistics include a spatial and/or temporal spread of the set of original pixel values. In this embodiment, the adaptation is based on the computation of a ‘spread’ of the pixel values that are processed to obtain a filtered pixel value. The spread is a measure based on differences between pixel values, the spread being preferably computed as a sum of absolute differences, a given absolute difference being obtained by subtracting an average pixel value from a given original pixel value. The local ‘spread’, i.e. the spread of the set of original pixels from which a filtered pixel value is calculated, is a good indicator of the local activity of the image. In this way, on the basis of the statistics of the pixels that are processed, it is possible to control locally the strength of the filter in order to prevent annoying artifacts where the image content is critical, e.g. on the edges. In pre-filtering, i.e. before entering a coding loop, defects around the moving objects and in particular the moving edges are eliminated by means of the adaptivity, based on the local statistical properties of the images in order to accomplish spatial filtering and also spatio-temporal filtering capable to be strongly effective against white Gaussian noise, without producing unacceptable artifacts in the image sequence. This is especially true when averaging filters are applied. Median filtering reduces both Gaussian and spiky noise.

Advantageously, the weighted pixel values are obtained by taking for each pixel in the set of original pixels, a combination of a portion α of the original pixel value and a portion 1−α of the central pixel value. In fact, α indicates the amount to which the original pixel values take the value of the central pixel value. In case, α=0, all original pixel values have the same value as the central pixel value, i.e. the original pixel values other than the central pixel value are not taken into account. This is preferably the case when the local spread is high. In case α=1, all original pixel values keep their the original value. This is preferably the case when the local spread is low. In general, the higher the spread, the lower α is. In this embodiment, the control signal consists of only one value, i.e. α, so that the implementation can be kept as small as possible.

The local spread is preferably furnished to a look-up table, whose output controls the weighting. A look-up table provides a simple and fast obtaining of the control of the weighting.

Preferred filtering operations in the present invention include median filtering and averaging filtering. When spread in temporal direction is used, e.g. in a spatio-temporal averaging filtering, it is preferred to use a second look-up table for the temporal direction, because pixel values in temporal directions are often differently correlated to each other than pixel values in spatial directions. Further, pixels in the temporal directions are less correlated to pixels in the spatial directions; therefore it is advantageous to lessen the weight of neighboring pixels in the temporal directions in the total result in comparison to pixel values in the spatial directions.

In case a temporal direction is used, the temporally displaced original pixel values preferably include two original pixel values from different fields (with unequal parity) in a same frame and at least one original pixel value of a previous frame. This embodiment saves memory compared to storing pixel values of fields with same parity in different frames, because in the latter case, at least two frames need to be stored to have two fields available.

Further, filtered temporally displaced pixel values may be used rather than temporally displaced original pixel values to reduce bandwidth requirements of the implementation of the filter.

U.S. Pat No. 5,621,468 discloses a motion adaptive spatio-temporal filtering method which is employed as a pre-filter in an image coding apparatus, which processes the temporal band-limitation of the video frame signals on the spatio-temporal domain along the trajectories of a moving component without temporal aliasing by using a filter having a band-limitation characteristic according to a desired temporal cutoff frequency and the velocity of moving components.

U.S. Pat No. 4,682,230 discloses an adaptive median filter system, which filters samples of an input signal. Further circuitry estimates the relative density of the noise in the input signal to generate the control signal supplied to the adaptive median filter. The adaptive filter selectively substitutes the sample having the median value for the current sample. If the current sample/median distance exceeds the processed inter M-tile distance, then the median valued sample is coupled to the output, and otherwise the current sample is coupled to the output. M-tile is a generic term relating to the relative position of a sample in a list of samples sorted according to their value. The median and upper and lower quartiles are special cases indicating values one-half, three-quarters and one-quarter of the way through the ordered list respectively. The inter M-tile distance is the difference between the upper M-tile value and the lower M-tile value and is a measure of the contrast of the image in the locality of the current sample.

U.S. Pat. No. 5,793,435 discloses de-interlacing of video using a variable coefficient spatio-temporal filter. The interlaced video signal is input to a video memory, which in turn provides a reference and plurality of offset video signals representing the pixel to be interpolated and spatially and temporally neighboring pixels. A coefficient index, transmitted with the interlaced video as an auxiliary signal, or derived from motion vectors transmitted with the interlaced video, or derived directly from the interlaced video signal, is applied to a coefficient memory to select a set of filter coefficients. The reference and offset signals are weighted together with the filter coefficients in the spatio-temporal interpolation filter, such as a FIR filter, to produce an interpolated video signal. The interpolated video signal is interleaved with the reference video signal, suitably delayed to compensate for filter processing time, to produce the progressive video signal.

The aforementioned and other aspects of the invention will be apparent from and elucidated with reference to the embodiments described hereinafter.

In the drawings:

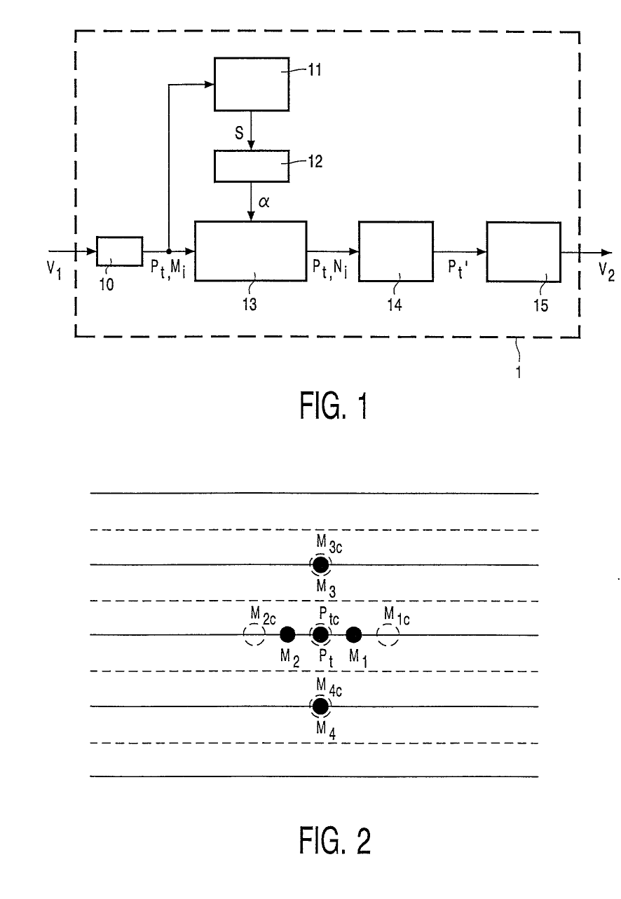

FIG. 1 shows an embodiment of an encoder according to the invention;

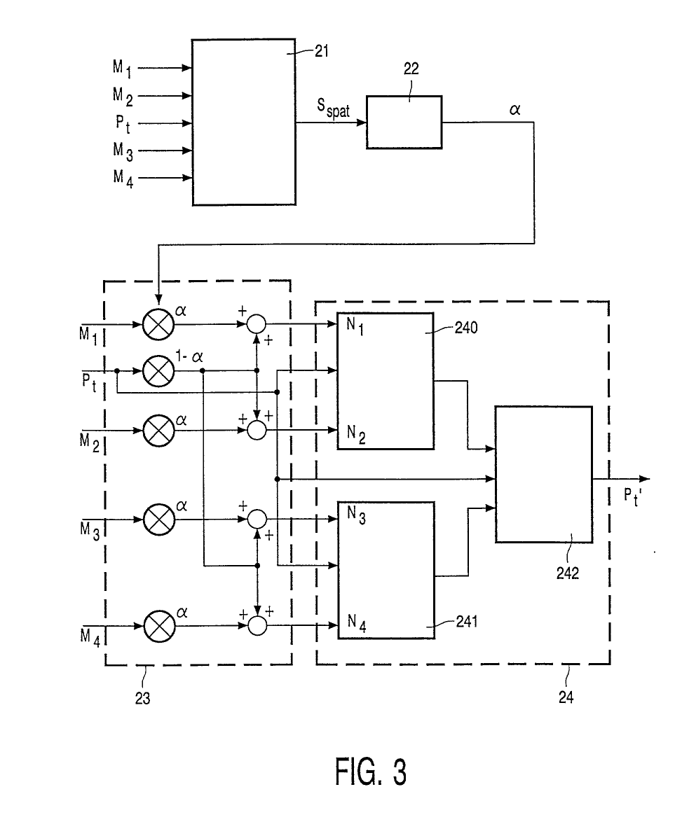

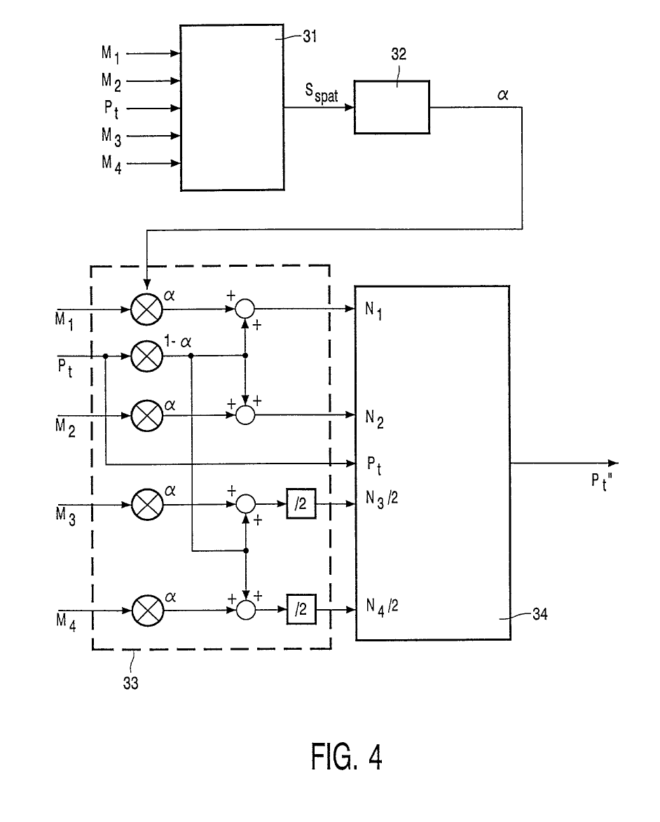

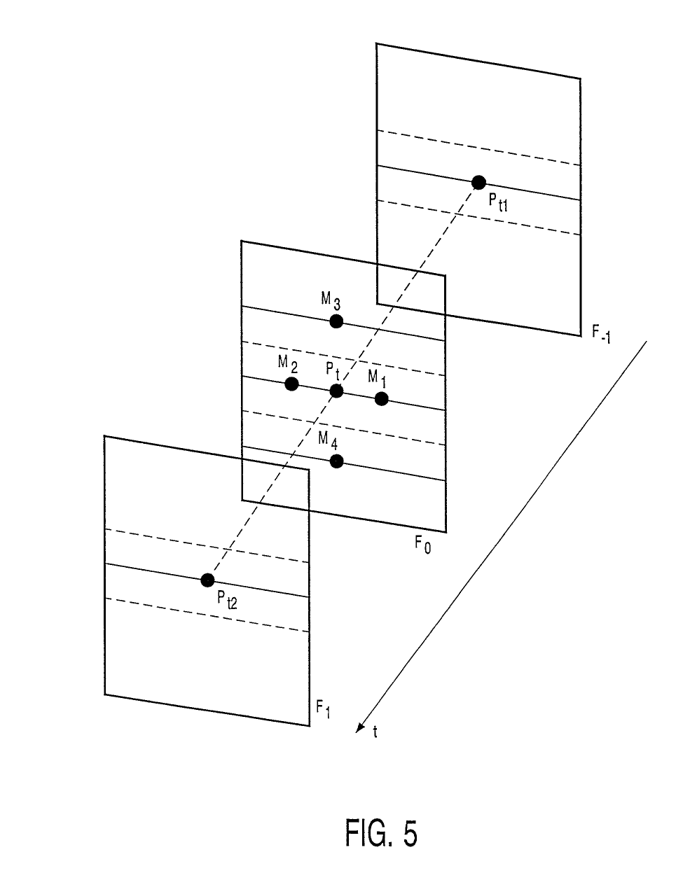

FIG. 2 shows input samples of adaptive filters as shown in FIGS. 3 and 4;

FIG. 3 shows an embodiment of an adaptive spatial median filter according to the invention;

FIG. 4 shows an embodiment of an adaptive spatial averaging filter according to the invention;

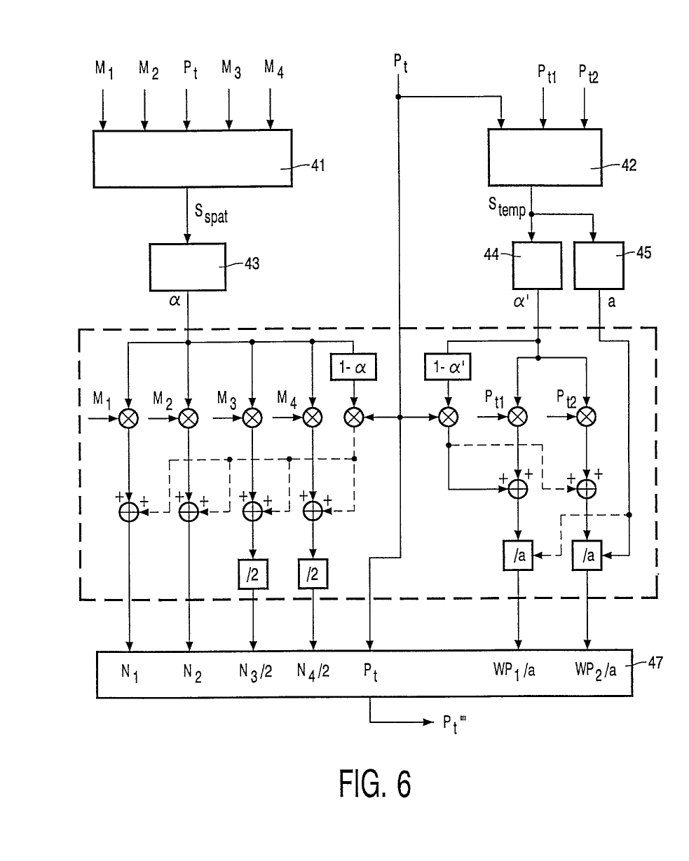

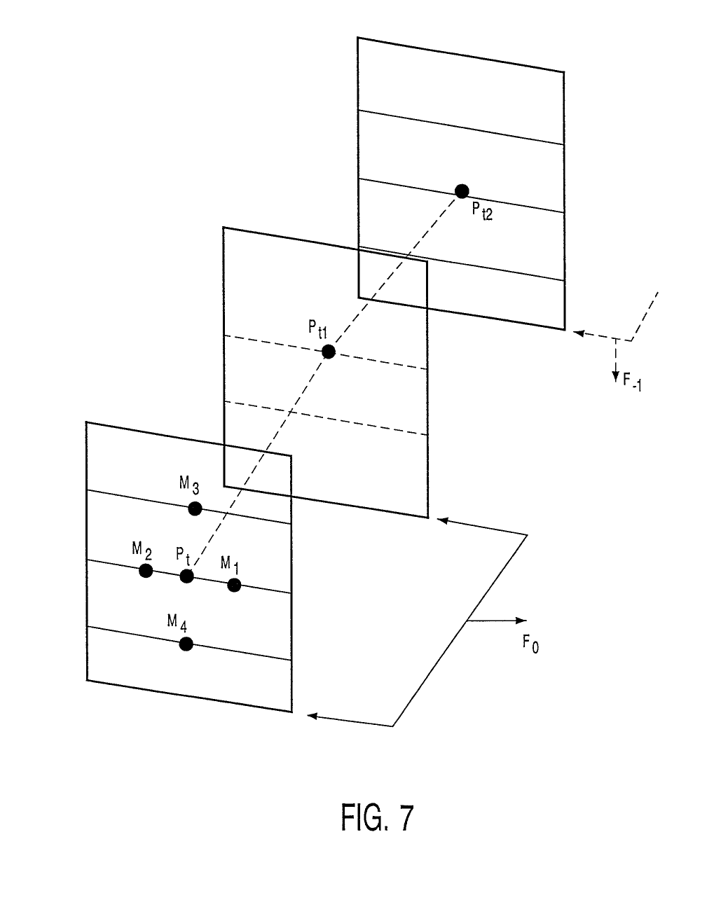

FIG. 5 shows a first set of input samples of an adaptive spatio-temporal averaging filter as shown in FIG. 6

FIG. 6 shows an embodiment of a spatio-temporal averaging filter according to the invention; and

FIG. 7 shows a second set of input samples of an adaptive spatio-temporal averaging filter as shown in FIG. 6

The drawings only show those elements that are necessary to understand the invention.

FIG. 1 shows an embodiment of an encoder 1 according to the invention, comprising an input unit 10, a computing unit 11, a look-up table 12, a weighting stage 13, a filter 14 and an encoding unit 15. An input video signal V1 is furnished to the encoder 1 and received in the input unit 10. In computing unit 11, a local spread S is obtained from a set of original pixel values indicated by Pₜ, Mᵢ. The result of the spread computation is furnished to the look-up table 12 to obtain a control signal α. In the weighting stage 13, the pixel values Pₜ, Mᵢ are weighted to obtain weighted pixel values Pₜ, Nᵢ. The weighted pixel values Pₜ, Nᵢ are filtered in the filter 14 to obtain a filtered pixel value Pₜ′. A plurality of pixel values Pₜ′ constitute a filtered video signal. According to advantageous embodiments of the invention, the filter 14 includes a spatial median filter, a spatial averaging filter, a spatio-temporal averaging filter or a combination of these. The filtered video signal constituted of the plurality of filtered pixel values Pₜ′ is encoded in the encoding unit 15 to obtain an encoded video signal V2. The encoding unit 15 is preferably an MPEG encoder.

FIG. 2 shows exemplary input samples of an adaptive filter according to the invention, e.g. a spatial median filter as shown in FIG. 3 or an spatial averaging filter as shown in FIG. 2. These input samples may also be used in shows a preferred example of input samples within one field. Dotted lines indicate image lines of a first field and continuous lines indicate image lines of a second field of a frame. A sample Pₜ is at a position of a calculated output sample. To calculate one filtered luminance sample, five samples Pₜ, M₁, M₂, M₃ and M₄ are used as input. In an MPEG encoder, which is a preferable field of application of the invention, horizontal color sub-sampling has normally already taken place at the input, according to the CCIR 4:2:2 format. Therefore, a horizontal distance between color samples (P_{tc}, M_{1c}, M_{2c}, M_{3c} and M_{4c} for U&V) is twice as large as for the luminance samples. Because experiments indicated that extra gain from the color samples is minor, color median processing can be skipped without significantly loosing quality. Median filtering per se is known in the art for its capability of preserving monotonic step edges and is therefore widely used for two-dimensional image noise smoothing. The implementation of a median filter requires a very simple digital non-linear operation: a sampled and quantized signal of length n is taken; across the signal, a window that spans m signal sample points is slid. The filter output is set equal to the median value of these m signal samples and is associated with the sample at a center of the window. The median of m scalar Xᵢ with i=1, . . . , m can be defined as the value X_{med} such that for all Y

$${\sum }_{i = 1}^{m} \vert {X}_{med} - {X}_{i} \vert \leq {\sum }_{i = 1}^{m} \vert Y - {X}_{i} \vert \qquad ( 1 )$$

In order to obtain a unique value as result, m must be an odd value. Suppose a random sample {X₁, . . . , Xₘ} from a population having a bi-exponential density function described by the expression:

$$f ( x ) = \frac{γ {e}^{- γ \vert x - δ \vert}}{2} \qquad ( 2 )$$

where γ is a scaling factor and δ is a maximum location parameter. The value of δ maximizing the likelihood function:

$$L ( δ ) = {\prod }_{i = 1}^{m} \frac{γ {e}^{- γ \vert {x}_{i} - δ ⌉}}{2} \qquad ( 3 )$$

is called the maximum likelihood estimate for δ based on the random sample {X₁, . . . , Xₘ}. By taking a logarithm of (3), it can be observed that the maximum likelihood estimate is clearly equal to Med[X₁, . . . , Xₘ]. The median is thus an optimal estimate of the location parameter in the maximum likelihood sense, if the input distribution is double exponential as in (2). In a similar manner, an average is the maximum likelihood estimate for a Gaussian distribution.

Conventionally, when the median filter is used for two-dimensional images, the intensity at every point in the image is replaced by the median of the intensity of the points contained in an m*m window centered at that point. It is known that the median filter is more effective than a linear filter for smoothing images with spiky noise distribution, because outliers are rejected by the median filtering. According to the properties mentioned above, the median filter tends to produce lower variances for the filtered noise when the distribution of the input noise has larger tails (e.g. spiky noise), but has lower performances then e.g. an averaging filter in case of uncorrelated (white) image noise with a Gaussian distribution; also when either Gaussian or impulsive noise are present, the latter is not completely suppressed as when only impulsive noise is present.

It has already been said that median filters are attractive for their capability of preserving monotonic step edges (width (m+1)/2) in the images, while an averaging filter tends unavoidably to blur edges, but is more effective against Gaussian noise. In an embodiment of the invention, a simple and easy implementation in real hardware is obtained by using a separable median filter. Such a separable filter performs median filtering operations by means of successive applications of one-dimensional median filters along different directions. Although the result is not identical to the full two dimensional median filter (using an m*m window), it can be observed that the separable filter provides comparable performances to the two-dimensional median filter. However, the main advantage is that in the full two-dimensional median filter, the center element is the median of m² points; by performing the median of m points separately along rows and columns a computational saving factor can be achieved. Separable median filters as such are known in the art.

Although the median has a good capability of preserving edges, if it is applied directly on the image data, strange effects can occur as blurring and ‘tails’ or ‘shadows’ around moving parts. Inter alia in order to minimize these undesired effects, the present invention provides an adaptive median filter, which filter is adaptive on the basis of local statistics of the image.

FIG. 3 shows an embodiment of an adaptive median filter according to the invention. The input samples Pₜ, Mᵢ as shown in FIG. 2 are furnished to a computing unit 21 and to a weighting stage 23. In the computing unit 21 a spatial spread Sₛₚₐₜ is calculated from the input samples, which spread Sₛₚₐₜ is furnished to a look-up table 22. Based on the spread Sₛₚₐₜ, a control signal α is obtained from the look-up table 22. The control signal α is furnished to the weighting stage 23, in which the input pixel values Pₜ, Mᵢ are weighted to obtain adapted pixel values Pₜ, Nᵢ. Note that in this embodiment, the central pixel Pₜ is unaffected by the weighting. In median filter 24 a median is taken from the adapted pixel values Pₜ, Nᵢ to obtain a filtered pixel value Pₜ′. The median filter 24 comprises three separate median filters 240, 241 and 242. These separate median filters 240, 241, 242 together form a total median filter. The operation of this embodiment is discussed below.

A spatial spread Sₛₚₐₜ of the five input samples Pₜ, M₁, M₂, M₃ and M₄ is computed as follows:

$$\begin{matrix}{M}_{ave} = \frac{( {P}_{t} + {M}_{1} + {M}_{2} + {M}_{3} + {M}_{4} )}{5} & ( 4 ) \\ {S}_{spat} = \frac{abs ( {M}_{ave} - {P}_{t} ) + {\sum }_{i = 1}^{4} abs ( {M}_{ave} - {M}_{i} )}{4} & ( 5 )\end{matrix}$$

The output of the spread of the luminance is translated via the look-up table 22 into the control parameter α for the weighting stage 23. In a preferred embodiment, the content of the look-up table 22 is downloadable from an external source. An exemplary look-up table 22 is given by:

Sₛₚₐₜ>10→α=0.5

Sₛₚₐₜ>15→α=0.35

Sₛₚₐₜ>20→α=0.2

Adapted pixel values are then obtained by:

N₁=αM₁+(1−α)Pₜ

N₂=αM₂+(1−α)Pₜ

N₃=αM₃+(1−α)Pₜ

N₄=αM₄+(1−α)Pₜ (7)

From these adapted pixel values, the median is computed in the filter 24 according to:

Pₜ′=Med[Med(N₁, N₂, Pₜ), Pₜ, Med(N₃, N₄, Pₜ)] (8)

As will be easily understood by those skilled in the art, the median is alternatively obtained by:

Pₜ′=Med[N₁, N₂, Pₜ, N₃, N₄)] (10)

An advantage of a median filter according to the invention, e.g. the median filter 24 as discussed above, is that a gradual filtering is obtained around the edges so that annoying effects in the sequence are avoided, or, at least, attenuated. When the spread Sₛₚₐₜ is larger, i.e. high spatial activity, e.g. around edges, then α is smaller so that the original central pixel is assigned a higher weight and the filtering of the median filter 24 is weaker.

FIG. 4 shows an embodiment of an adaptive spatial averaging filter according to the invention. Computing unit 31 and look-up table 32 are similar to computing unit 21 and look-up table 22 as shown in FIG. 3. The look-up table 32 is coupled to a weighting stage 33, in which the input samples Pₜ, Mᵢ are weighted to obtain adapted pixel values Pₜ, Nᵢ that are furnished to a spatial averaging filter 34.

As stated before, a spatial averaging filter is the maximum likelihood estimate for the Gaussian distribution. Since noise present in video sequences is usually a sum of effects due to different sources (acquisition, pre-amplifying, amplifying, transmission and handling operations), it can be assumed in a lot of cases that the noise distribution is Gaussian (theorem of the central limit). In these cases, an averaging filter is preferred. By using an adaptive averaging filter according to the invention in a pre-filtering stage of an encoding arrangement, effective noise filtering is obtained which results in a significant bit-rate reduction. However, it is necessary to pay attention to the quality of the resulting image, since blurring of the spatial and temporal edges unavoidably occur. An object of the invention in relation to averaging filters is to control such blurring in order to achieve an acceptable quality for the filtered sequence. For an adaptive spatial averaging filter, the adaptivity based on local statistical properties (spread/activity) of the image can be exploited as it has been described for the median filter. The result is an adaptive spatial averaging filter, which better preserves the quality of the images.

Computation of the adapted pixel values is similar to the computation previously described in relation to the adaptive median filter. Also in this case, the filtering of the chrominance may be skipped, because its contribution to the final result is minor.

An output of the adaptive spatial averaging filter is computed as follows:

$${P}_{t}^{′′} = \frac{( {N}_{1} + {N}_{2} + {N}_{3} / 2 + {N}_{4} / 2 + {P}_{t} )}{4} \qquad ( 11 )$$

It is noted, that the pixels N₃ and N₄ are divided by a factor 2 to reduce their weight in the final average because they distance to Pₜ is double compared to N₁ and N₂, since the filtering is applied within a field, and are therefore ‘less correlated’.

When a very low level of noise is present, the image looks obviously much smoother than the original; anyway, by means of a proper adjustment of the look-up table, this effect can be statically controlled, achieving a good trade-off between the noise reduction and the good quality of the video sequence.

FIG. 5 shows input samples in both spatial and temporal directions in which figure t denotes time. In frame F₀ a set of pixels Pₜ, Mᵢ is taken similar to the luminance pixels in FIG. 2. In addition, in this embodiment, pixel values Pₜ₁, and Pₜ₂ are taken from fields with same parity in both a previous frame F₋₁ and a future frame F₁. Here a window of seven pixels is considered: five pixels of the present field, one pixel of the previous field with same parity and one of the future field with same parity. It is advantageous to include filtering operations in the temporal direction, because both spatial and temporal noise are often present. A reduction of the level of noise can be useful for motion estimation either, provided that the motion estimation itself is thought and realized strictly related with the pre-processing part and consequently no too much affected by the increased smoothness of the filtered image, otherwise the quality of the motion vectors can be worse, resulting in some additional coding noise that compromises the final result.

FIG. 6 shows an embodiment of a spatio-temporal averaging filter according to the invention. In order to reduce annoying effects, such as ‘tails’, ‘shadows’ or simply blurring in moving objects, an adaptation step is used in order to perform an effective and not image-damaging averaging spatio-temporal filtering. Also in this case, the adaptivity is based on the local statistical properties of the image, even if it is now necessary to make a distinction between the pixels belonging to the same field and the pixels belonging to the previous or the next field with same parity. The embodiment comprises a computing unit 41 for computing a spatial spread which is similar to computing units 21 and 31 as shown in FIGS. 3 and 4. The computing unit 41 is coupled to a look-up table 43. In this exemplary embodiment, a spread of the pixels belonging to the same field (Pₜ, Mᵢ) and a spread of the pixels (Pₜ, Pₜ₁, Pₜ₂) belonging to different fields with same parity are separately computed. In other words, the computation of the spread in spatial directions is separated from the computation of the spread in the temporal directions. For computing the temporal spread Sₜₑₘₚ the embodiment comprises a second computing unit 42.

The temporal spread is computed as follows:

$$\begin{matrix}{P}_{t , ave} = \frac{( {P}_{t} + {P}_{t1} + {P}_{t2} )}{3} & ( 12 ) \\ {S}_{temp} = \frac{abs ( {P}_{t , ave} - {P}_{t} ) + {\sum }_{j = 1}^{2} abs ( {P}_{t , ave} - {P}_{tj} )}{2} & ( 13 )\end{matrix}$$

The result of the temporal spread is translated via a temporal look-up table 44 into a control parameter α′ necessary to perform weighting operations on the temporal pixel values Pₜ, Pₜ₁ and Pₜ₂.

After the computation of the control parameters α (spatial) and α′ (temporal), the weighting operation is performed in both the spatial and temporal direction, in the spatial direction according to the formula (5) and in the temporal direction according to:

WP₁=α′Pₜ₁+(1−α′)Pₜ

WP₂=α′Pₜ₂+(1−α′)Pₜ (14)

Finally, an output of the spatio-temporal averaging filter 47 is computed according to:

$${P}_{t}^{′′′} = \frac{( {N}_{1} + {N}_{2} + {N}_{3} / 2 + {N}_{4} / 2 + {P}_{t} + {WP}_{1} / a + {WP}_{2} / a )}{4 + 2 / a} \qquad ( 15 )$$

Note that the weighted pixel values WP₁ and WP₂ are divided by a control parameter α. The control parameter α is obtained from a look-up table 45 and is a number ≧1, depending on the local temporal spread in the three pixels Pₜ, Pₜ₁ and Pₜ₂: the higher the spread, the higher α, so that the weight of the previous and the next pixel in the average is smaller. By adjusting the look-up table 45 properly, it is possible to control the strength of the filter in the temporal direction in order to achieve a good quality of the image, once again exploiting the adaptively to the image temporal content so that annoying effects connected with edges blurring are reduced.

The described filter belongs to the class of Finite Impulse Response (FIR) filters. The FIR structure requires keeping in memory the present F₀, the future F₁ and the previous F₋₁ original frames for the filtering operation. In order to save memory, it is preferred to use pixels of past fields and with unequal parity, as shown in FIG. 7. In this case only the present F₀ and the previous frame F₋₁ have to be stored. This allows a reduction of the memory size as far as the implementation of the filter is concerned, without significantly affecting the resulting quality of the filtered image. Instead of previous original frames, previous filtered frames may be used. In the case that for previous frames in FIG. 7, filtered frames are taken, an Infinite Impulse Response (IIR) filter structure is obtained. This structure has advantages regarding memory usage and bandwidth.

Examples of devices that encode an image sequence, in which noise filtering according to the invention is applied, are: MPEG-2 encoders, digital video recorders (e.g. DVD-video recording, digital-VHS, HDD VCR) etc.

Adaptive filters according to this invention may also be applied inside a motion-compensating coding loop. Advantageously, an adaptive filter is used in a pre-filtering stage in combination with a temporal filter within the coding loop.

In an embodiment of the invention, at least two adaptive noise filters are combined, e.g. a spatial median filter and an adaptive spatial averaging filter, wherein the filtering is controlled by characteristics of the image sequence. A noise estimator may be added that analyses the level of the present noise. Such a noise estimator is an interesting tool to control the adaptive filters. Advantageously, the noise estimator is arranged to identify the statistical properties of the present noise in order to opportunely switch dynamically between the median and the spatial and/or spatio-temporal averaging filter.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

In summary, noise filtering an image sequence is provided wherein statistics in at least one image of the image sequence is determined and at least one filtered pixel value is calculated from a set of original pixel values obtained from the at least one image, wherein the original pixel values are weighted under control of the statistics.

1. A method of noise filtering an image sequence (V1), characterized in that the method comprises:
determining (11) statistics in at least one image of the image sequence (V1); and
calculating (14) at least one filtered pixel value (Pₜ′) from a set of original pixel values (Pₜ, Mᵢ) obtained from the at least one image, wherein the original pixel values (Pₜ, Mᵢ) are weighted (13) under control (12, α) of the statistics (11).

2. A method as claimed in claim 1, wherein the step of calculating comprises:
weighting (13) the set of original pixel values (Pₜ, Mᵢ) under control (12, α) of the statistics (11) to obtain a weighted set of pixel values (Pₜ, Nᵢ); and
furnishing the weighted set of pixel values (Pₜ, Nᵢ) to a static filter, in which static filter the at least one filtered pixel value (Pₜ′) is calculated from the weighted set of pixel values (Pₜ, Nᵢ).

3. A method as claimed in claim 1, wherein the statistics (11) include a spatial and/or temporal spread (S) of the set of original pixel values (Pₜ, Mᵢ).

4. A method as claimed in claim 3, wherein the spatial and/or temporal spread (S) is a sum of absolute differences, a given absolute difference being obtained by subtracting an average pixel value from a given original pixel value (Pₜ, Mᵢ).

5. A method as claimed in claim 1, wherein the set of original pixel values (Pₜ, Mᵢ) include a central pixel value (Pₜ) and spatially and/or temporally surrounding pixel values (Mᵢ), wherein as a result of the noise filtering, the central pixel value (Pₜ) is replaced by the filtered pixel value (Pₜ′).

6. A method as claimed in claim 2, wherein the set of weighted pixel values (Pₜ, Nᵢ) is obtained by taking for each pixel in the set of original pixels (Pₜ, Mᵢ), a combination of a portion α of the original pixel value (Pₜ, Mᵢ) and a portion 1−α of a central pixel value (Pₜ).

7. A method as claimed in claim 1,
wherein the statistics (11) are furnished to a look-up table (12), from which look-up table (12) a control signal (α) is obtained, which control signal (α) controls the weighting (13).

8. A method as claimed in claim 2,
wherein the at least one filtered pixel value (Pₜ′) is obtained by calculating (14) a median of the weighted set of pixel values (Pₜ, Nᵢ).

9. A method as claimed in claim 2,
wherein the at least one filtered pixel value (Pₜ′) is obtained by calculating (14) an average of the weighted set of pixel values (Pₜ, Nᵢ).

10. A method as claimed in claim 9, the method comprising:
determining (41) a spatial spread (Sₛₚₐₜ) calculated from spatially displaced original pixel values (Pₜ, Mᵢ) in the set of original pixel values (Pₜ, Mᵢ, Pₜ₁, Pₜ₂);
determining (42) a temporal spread (Sₜₑₘₚ) calculated from temporally displaced original pixel values (Pₜ, Pₜ₁, Pₜ₂) in the set of original pixel values (Pₜ, Mᵢ, Pₜ₁, Pₜ₂); and
weighting (46) the spatially displaced original pixel values (Pₜ, Mᵢ) under control (43) of the spatial spread (Sₛₚₐₜ) and the temporally displaced original pixel values (Pₜ,Pₜ₁, Pₜ₂) under control (44, 45) of the temporal spread (Sₜₑₘₚ).

11. A method as claimed in claim 10, wherein the weighted temporally displaced original pixel values (WP₁, WP₂) are divided (a) to lessen their weight in the filtering (47).

12. A method as claimed in claim 10, wherein the temporally displaced original pixel values include two original pixel values (Pₜ₁, Pₜ₂) from different fields in a same frame (F₀) and at least one original pixel value of a previous frame (F₋₁).

13. A method as claimed in claim 12, wherein filtered temporally displaced pixel values are used rather than temporally displaced original pixel values.

14. A method of encoding (1) an image sequence (V1), wherein the image sequence (V1) is noise filtered according to a method as claimed in claim 1.

15. A device for noise filtering an image sequence, the device comprising:
computing means (11) for determining statistics in at least one image of the image sequence (V1); and
filtering means (14) for calculating at least one filtered pixel value (Pₜ′) from a set of original pixel values (Pₜ, Mᵢ) obtained from the at least one image, wherein the original pixel values (Pₜ, Mᵢ) are weighted (13) under control (12, α) of the statistics (11).

16. A device for encoding (1) an image sequence (V1), the device comprising a device for noise filtering as claimed in claim 15.
